(19) United States
(12) Patent Application Publication
(10) Pub. No.: US 2004/0177752 A1
(43) Pub. Date: Sep. 16, 2004

(54) Connecting element for connecting a piston to a restoring element

(76) Inventors: Wolfgang Buchhauser, Teugn (DE); Adolf Einberger, Rimbach (DE); Thomas Grossner, Neutraubling (DE); Christoph Klesse, Worth A.D.Donau (DE); Martin Werner, Hemau (DE)

Correspondence Address: Andreas Grubert, Baker Botts L.L.P., One Shell Plaza, 910 Louisiana, Houston, TX, 77002-4995, US

(21) Appl. No.: 10/810,104

(22) Filed: Mar. 26, 2004

Related U.S. Application Data
(63) Continuation of application No. PCT/DE02/03458, filed on Sep. 16, 2002.

(30) Foreign Application Priority Data
Sep. 28, 2001 (DE) 10147981.6

(51) Int. Cl. F16J 1/10

(52) U.S. Cl. 92/129; 92/130 C

(57) ABSTRACT

A connecting element (1) connects a piston (2) with a restoring element (6) for a radial piston pump. The piston (2) is displaceably mounted in a cylinder (4) and can be restored from an upper dead-centre position by means of the restoring element (6). The connecting element (1) is connected to the piston (2) in a positive fit.

### CROSS REFERENCE TO RELATED APPLICATION

This application is a continuation of copending International Application No. PCT/DE02/03458 filed Sep. 16, 2002 which designates the United States, and claims priority to German application no. 101 47 981.6 filed Sep. 28, 2001.

### TECHNICAL FIELD OF THE INVENTION

The present invention relates to a connecting element for connecting a piston to a restoring element of a radial piston pump, the piston being displaceably mounted in a cylinder, able to be restored by means of the restoring element and in contact with a piston shoe.

### DESCRIPTION OF THE RELATED ART

Radial piston pumps are known in various embodiments. FIG. 4 shows a simplified sectional view of essential components of a radial piston pump. The radial piston pump shown in FIG. 4 is a pump with internal support in which a lifting movement of an eccentric 17 is transferred with the aid of an eccentric ring 13 via a piston shoe 3 to the piston 2 oscillating in a radial direction. Only one piston 2 is shown in FIG. 4 to simplify the drawing. The piston 2 is mounted in a cylinder 4, and the piston 2 is restored from its upper dead-center position by means of a return spring 6, a support piston 5 and an annular element 14. The annular element 14 is mounted on the piston 2 by means of shrink fitting or press fitting. This results in an interference-fit connection between the piston 2 and the annular element 14. As the piston 2 is restored, the spring force of the spring 6 acts directly on the annular element 14 by means of the support piston 5.

During operation, the annular element 14 then suffers frequent damage, firstly because the return force of the spring 6 is transferred via the annular element 14, and secondly because the annular element 14 must be tightly fixed to the piston 2. The material of the annular element 14 must therefore be chosen firstly so that no cracks arise as a result of bending stresses produced by the spring force or resulting from the shrink-fitting process, and secondly so that the interference fit between the annular element 14 and the piston 2 is sufficiently tight.

Thus in the state of the art, an annular element has been proposed that eliminates the conflict between the different material requirements of the annular element. Such an annular element is shown in FIG. 5. Here, the functions performed by the annular element are transferred to two components, one being an annular base 14, which is shrink-fitted to the piston 2 in a known manner, and the second component being a pierced disk 15 which acts against a small step in the annular base 14 and thus enables the piston 2 to be restored from its upper dead-center point by the return spring 6. The optimum material for each of the two components 14 and 15 can thus be selected. Hence the annular base 14 can be made from a relatively ductile material to enable simple shrink fitting, and the pierced disk 15 can be made from a very hard material in order to absorb the bending stresses that arise.

The known connecting elements for connecting the piston 2 to the piston shoe 3 have the disadvantage, however, that they are relatively complex to manufacture and assemble and are hence very expensive. In addition, suitable materials for good interference fits are technically difficult to work with in production.

### SUMMARY OF THE INVENTION

It is thus the object of the present invention to provide a connecting element for connecting a piston to a restoring element that can be manufactured simply and cheaply and that enables a reliable connection of the two components.

This object can be achieved by a a one-piece connecting element for a radial piston pump for connecting a piston to a restoring element, wherein the piston is displaceably mounted in a cylinder and can be restored from an upper dead-center position by means of the restoring element, and the connecting element is connected to the piston with a positive fit, the positive fit being effected by means of a snap-in connection between the connecting element and at least one recess formed in the piston.

The object can also be achieved by a radial piston pump comprising:

a radial piston having at least one recess displaceably mounted in a cylinder;

a restoring element for restoring said piston from an upper dead-center position;

a one-piece connecting element for connecting said piston to said restoring element with a positive fit comprising a snap-in connection for connecting the connecting element and the at least one recess formed in the piston.

The connecting element can be an essentially annular component, an inner region of the connecting element providing a positive-fit connection to the piston, and an outer region of the connecting element providing a connection to the return element. The inner region can be arranged in the axial direction of the connecting element, and the outer region is arranged on different planes. The inner region can be formed by at least one mating surface bent from a main plane of the one-piece connecting element. The inner region can be formed by four mating surfaces that engage in the recess formed in the piston. The mating surfaces can be arranged symmetrically around the inner circumference of the connecting element. The recess formed in the piston can be an annular groove.

In the connecting element according to the invention for connecting a piston to a restoring element of a radial piston pump, the connection is no longer designed as an interference fit but as a positive fit. This means that the costly shrink fitting or press fitting of the annular element onto the piston employed in the state of the art can be dispensed with. By simplifying the assembly process, not only is process reliability increased but there are also clear cost benefits. Furthermore, the connecting element according to the invention can have a very simple geometrical design. Incorrect assembly of the connecting element according to the invention can be identified immediately, for example, by a simple-to-perform pull-off test. The connecting element according to the invention may be correctly engaged, thus providing the positive fit, or else it is pulled off the piston during the pull-off test. Incorrect assembly can thereby always be detected with absolute certainty.

According to a preferred embodiment of the present invention, the connecting element is made in two pieces from a first piece and a second piece. The first piece is arranged with a positive fit in a recess formed in the piston, and the second piece rests against the first piece at one end, and is connected to the piston shoe at the other end. By this means, different materials can be used for the two pieces of the connecting element, so that the two pieces can be optimized with regard to their respective functional use. Preferably, the first piece is formed as a retaining ring or circlip, so that standard components can be used for the first piece. This results in considerable cost benefits. In addition, the second piece is preferably designed as a simple-to-produce pierced disk, so that it is also possible in this case to achieve cost benefits from manufacture. Since the connecting element is also connected to the piston shoe, it can also enable the piston shoe to be restored at the same time. It should be noted that the return element can be in direct or indirect contact with the piston shoe here.

According to another preferred embodiment of the present invention, the connecting element is designed as an essentially annular component made from a single piece. An inner region of the connecting element provides a positive-fit connection to the piston. An outer region of the connecting element provides a connection to the return element and the piston shoe respectively. Thus according to this preferred embodiment, the number of components can be reduced, resulting in particularly quick and simple assembly. Preferably, the inner region of the connecting element is formed by at least one surface bent from a main plane of the one-piece connecting element. In a particularly preferred embodiment, the inner region providing the positive-fit connection is provided by four symmetrically arranged identical surfaces. This results in excellent force distribution. Since the surfaces for the positive-fit connection can simply be bent down out of the main body of the connecting element, this makes it particularly simple and cheap to manufacture.

The recess in the piston for the positive-fit connection is preferably formed as an annular groove. This also enables the recess to be made in the piston simply and cheaply. It should be noted that it is also possible, however, to form recesses in the piston that match the respective mating areas of the connecting element to produce the positive-fit connection.

### BRIEF DESCRIPTION OF THE DRAWINGS

A number of exemplary embodiments of the present invention are described below with reference to the drawing, in which

FIG. 1 shows a schematic sectional view of a connecting element according to a first exemplary embodiment of the present invention,

FIG. 2 shows a schematic sectional view of a connecting element according to a second exemplary embodiment of the present invention,

FIG. 3 shows a schematic plan view of the connecting element shown in FIG. 2,

FIG. 4 shows a schematic sectional view of a connecting element according to the state of the art,

FIG. 5 shows a schematic sectional view of a connecting element according to a further state of the art.

### DETAILED DESCRIPTION OF THE PREFERRED EMBODIMENTS

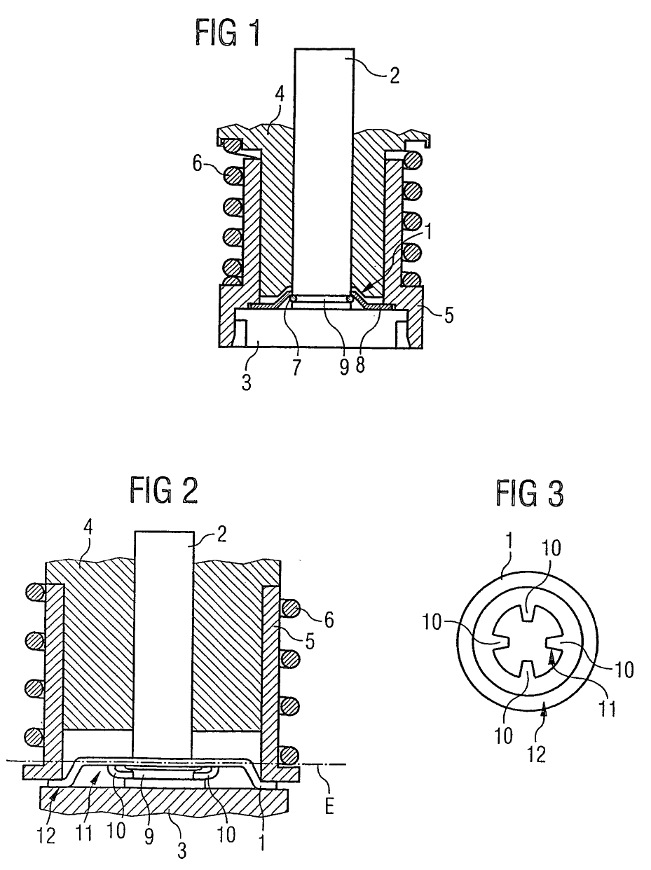

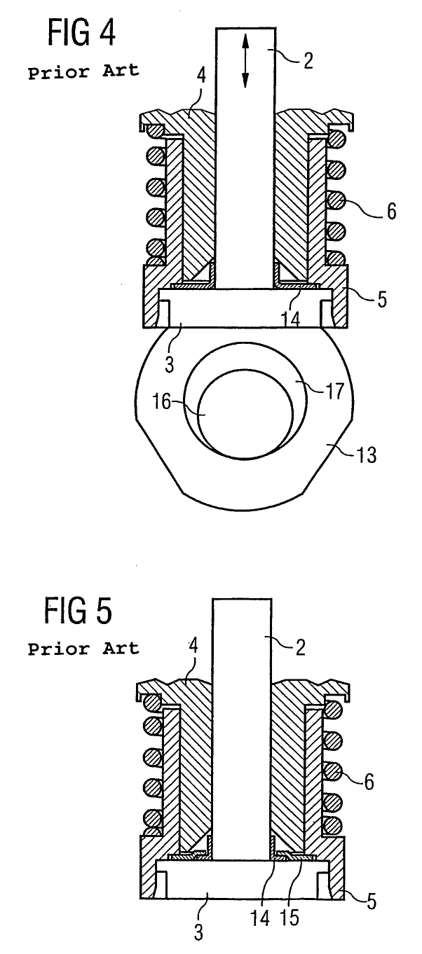

A connecting element 1 according to a first exemplary embodiment of the present invention is described below with reference to FIG. 1.

As shown in FIG. 1, the connecting element 1 is formed in two pieces and comprises a first piece and a second piece. The first piece is a retaining ring 7 and is arranged with a positive fit in a groove 9 formed in a piston 2. The second piece is formed as a pierced disk 8 whose inner diameter is slightly larger than the outer diameter of the piston 2.

As shown in FIG. 1, the inner region of the pierced disk 8 contacts the retaining ring 7 in such a way that it rests on the retaining ring 7. At the outer region, the pierced disk 8 is connected to a piston shoe 3 on one side, and on the other side the pierced disk 8 rests against a recess in a support piston 5. The pierced disk rests on that side of the securing ring facing away from the piston shoe 3. The pierced disk 8 comprises a first outer plane, in which it is in contact with the piston shoe 3 on one side and the support piston 5 on the other side, a second inner plane, with which it is in contact with the retaining ring 7, and a tapering region that connects together the outer and the inner plane.

The support piston 5 is moved by means of a return spring 6 to enable the piston 2 to be restored from its upper dead-center position. The piston 2 is mounted in a cylinder 4 so as to allow movement to and fro. The piston 2 is restored from the upper dead-center position shown in FIG. 1 by means of the support piston 5 and the outer region of the pierced disk 8, which results in the piston 2 being pressed downwards by means of the inner region of the pierced disk 8 and the retaining ring 7. At the same time, the piston shoe 3 is also moved back by means of the support piston 5 and the pierced disk 8.

The groove 9 in the piston 2 is formed as an annular groove, so that a low-cost standard retaining ring or cirelip can be used as the first piece 7.

Since a positive-fit connection is now formed between the piston 2 and the return spring 6, significantly fewer problems arising from material fatigue in the connecting element 1 result than with the interference-fit connections used in the state of the art. Thus according to the invention, the disadvantageous shrink-fitting or press-fitting of the connecting element onto the piston can be dispensed with.

FIGS. 2 and 3 show a connecting element 1 according to a second exemplary embodiment of the present invention, where identical or functionally identical parts are labeled with the same reference numbers as in the first exemplary embodiment.

As shown in FIG. 2, according to the second exemplary embodiment, the connecting element 1 is formed as a single piece. This allows a reduction in the number of parts and, in particular, a significant reduction in the manufacturing costs and assembly costs for the connecting element 1.

As can be seen in particular from FIG. 3, the connecting element 1 comprises an inner region 11 and an outer region 12. The inner region 11 facilitates the positive-fit connection between the connecting element 1 and the piston 2. The outer region 12 is used to pick up and transfer the spring force of the return spring 6, in order to restore the piston 2 from its upper dead-center position.

As shown in FIG. 3, four mating surfaces 10 are formed at the inner region 11 of the connecting element 1 that engage in a groove 9 formed in the piston 2 to produce a positive-fit connection between the connecting element 1 and the piston 2. The mating surfaces 10 are manufactured here by punching and bending out from a base plane E of the substantially disk-shaped connecting element 1. The outer regions 12 are similarly manufactured by bending the outer edge of the connecting element 1 out of the base plane E. The outer regions 12 are arranged here in a different plane from the inner regions 11 (See FIG. 2).

The connecting element 1 can be manufactured, for example, by punching from a sheet of material and then bending the inner regions into the mating surfaces 10 and the outer edge into the outer region 12 respectively.

It should be noted that any geometrical form can be chosen for both the groove 9 and the mating surfaces 10 of the connecting element 1. For simple manufacture, however, it is preferred if simple geometric shapes are used. For example, the groove 9 is designed as an annular groove.

Thus the present invention relates to a connecting element 1 for connecting a piston 2 to a piston shoe 3 of a radial piston pump. The piston 2 is displaceably mounted in a cylinder 4 and can be restored from its upper dead-center position by means of a restoring element 6. The connecting element 1 is connected to the piston 2 in a positive fit.

The present invention is not limited to the exemplary embodiments presented. Various deviations and changes can be implemented without going beyond the scope of the invention.

We claim:

1. A one-piece connecting element for a radial piston pump for connecting a piston to a restoring element, wherein the piston is displaceably mounted in a cylinder and can be restored from an upper dead-center position by means of the restoring element, and the connecting element is connected to the piston with a positive fit, the positive fit being effected by means of a snap-in connection between the connecting element and at least one recess formed in the piston.

2. The connecting element as claimed in claim 1, wherein the connecting element is an essentially annular component, an inner region of the connecting element providing a positive-fit connection to the piston, and an outer region of the connecting element providing a connection to the return element.

3. The connecting element as claimed in claim 2, wherein the inner region is arranged in the axial direction of the connecting element, and the outer region is arranged on different planes.

4. The connecting element as claimed in claim 2, wherein the inner region is formed by at least one mating surface bent from a main plane of the one-piece connecting element.

5. The connecting element as claimed in claim 3, wherein the inner region is formed by at least one mating surface bent from a main plane of the one-piece connecting element.

6. The connecting element as claimed in claim 4, wherein the inner region is formed by four mating surfaces that engage in the recess formed in the piston.

7. The connecting element as claimed in claim 5, wherein the inner region is formed by four mating surfaces that engage in the recess formed in the piston.

8. The connecting element as claimed in claim 6, wherein the mating surfaces are arranged symmetrically around the inner circumference of the connecting element.

9. The connecting element as claimed in claim 7, wherein the mating surfaces are arranged symmetrically around the inner circumference of the connecting element.

10. The connecting element as claimed in claim 1, wherein the recess formed in the piston is an annular groove.

11. A radial piston pump comprising:
a radial piston having at least one recess displaceably mounted in a cylinder;
a restoring element for restoring said piston from an upper dead-center position;
a one-piece connecting element for connecting said piston to said restoring element with a positive fit comprising a snap-in connection for connecting the connecting element and the at least one recess formed in the piston.

12. The connecting element as claimed in claim 11, wherein the connecting element is an essentially annular component, an inner region of the connecting element providing a positive-fit connection to the piston, and an outer region of the connecting element providing a connection to the return element.

13. The connecting element as claimed in claim 12, wherein the inner region is arranged in the axial direction of the connecting element, and the outer region is arranged on different planes.

14. The connecting element as claimed in claim 12, wherein the inner region is formed by at least one mating surface bent from a main plane of the one-piece connecting element.

15. The connecting element as claimed in claim 13, wherein the inner region is formed by at least one mating surface bent from a main plane of the one-piece connecting element.

16. The connecting element as claimed in claim 14, wherein the inner region is formed by four mating surfaces that engage in the recess formed in the piston.

17. The connecting element as claimed in claim 15, wherein the inner region is formed by four mating surfaces that engage in the recess formed in the piston.

18. The connecting element as claimed in claim 16, wherein the mating surfaces are arranged symmetrically around the inner circumference of the connecting element.

19. The connecting element as claimed in claim 17, wherein the mating surfaces are arranged symmetrically around the inner circumference of the connecting element.

20. The connecting element as claimed in claim 11, wherein the recess formed in the piston is an annular groove.
